(19) United States
(12) Patent Application Publication
(10) Pub. No.: US 2013/0111212 A1
(43) Pub. Date: May 2, 2013

(54) METHODS TO PROVIDE DIGITAL SIGNATURE TO SECURE FLASH PROGRAMMING FUNCTION

(71) Applicants: Kevin M. Baltes, Wixom, MI (US); Mark H. Costin, Bloomfield Township, MI (US); Thomas M. Forest, Macomb, MI (US); Ansaf I. Alrabady, Livonia, MI (US)

(72) Inventors: Kevin M. Baltes, Wixom, MI (US); Mark H. Costin, Bloomfield Township, MI (US); Thomas M. Forest, Macomb, MI (US); Ansaf I. Alrabady, Livonia, MI (US)

(73) Assignee: GM GLOBAL TECHNOLOGY OPERATIONS LLC, DETROIT, MI (US)

(21) Appl. No.: 13/557,031

(22) Filed: Jul. 24, 2012

Related U.S. Application Data
(60) Provisional application No. 61/552,931, filed on Oct. 28, 2011.

(51) Int. Cl. H04L 9/32

(52) U.S. Cl. 713/176

(57) ABSTRACT

A method for providing digital signatures for authenticating the source and content of binary files which are flash programmed into automotive embedded controllers. A piece of electronic content is digitally signed on a signing server by creating a hash value and encrypting it using the signer's private key. The content file and digital signature files are then delivered using one of several alternative approaches to a programming tool, which in turn loads the content and signature files onto the controller on which the content will execute. The controller verifies the content by decrypting the signature file to restore the hash value, and comparing the decrypted hash value to a hash value calculated from the content itself. Multiple signature files for a piece of content are supported.

### CROSS-REFERENCE TO RELATED APPLICATIONS

This application claims the benefit of the priority date of U.S. Provisional Patent Application Ser. No. 61/552,931, titled, Methods to Provide Digital Signature to Secure Flash Programming Function, filed Oct. 28, 2011.

### BACKGROUND OF THE INVENTION

1. Field of the Invention

This invention relates generally to a method for authenticating files that are programmed into embedded controllers and, more particularly, to a method for using asymmetric key digital signatures to authenticate the source and content of binary files that are programmed into automotive embedded controllers, including several alternative approaches to handling the content and signature files from creation to consumption.

2. Discussion of the Related Art

As more and more digital technology is introduced into automobiles, the threat of malicious software and hardware manipulation increases. In particular, the software required to run various controllers on a vehicle can come from many sources. If a piece of counterfeit software (not authentic and therefore not properly validated) is used, or a piece of maliciously-designed software is used, the performance and reliability of the vehicle can be compromised and the vehicle and its systems could exhibit unintended behavior.

Digital signatures are a known technique that can be used to verify authenticity of electronic messages. However, digital signatures have not been widely used for authentication of controller-embedded software and other content because of the complexity of managing the digital signature file or files from the content source all the way through the content execution on the controller. A method for overcoming this limitation is needed, so that the digital signatures can be effectively managed by an auto manufacturer and the source and content of files that are programmed into automotive embedded controllers can be properly verified.

### SUMMARY OF THE INVENTION

In accordance with the teachings of the present invention, a method is disclosed for providing digital signatures for authenticating the source and content of binary files that are flash programmed into automotive embedded controllers. A piece of electronic content is digitally signed on a signing server by creating a hash value and encrypting it using the signer's private key. The content and digital signature files are then delivered using one of several alternative approaches to a programming tool, which in turn loads the content and signature files onto the controller on which the content will execute. The controller verifies the content by decrypting the signature file to restore the hash value, and comparing the hash value to a hash value calculated from the content itself. Multiple signature files for a piece of content may be needed, and are accommodated in the disclosed methods.

Additional features of the present invention will become apparent from the following description and appended claims, taken in conjunction with the accompanying drawings.

### BRIEF DESCRIPTION OF THE DRAWINGS

FIG. 1 is a block diagram of a standard method of signing and verifying electronic content using a digital signature;

FIG. 2 is a block diagram of a method for signing and verifying electronic content using a digital signature including the delivery of content and signature files from programming source to executing controller;

FIG. 3 is a schematic diagram showing how electronic content and a digital signature are physically delivered to a controller in a vehicle;

FIG. 4 is a block diagram of a first alternative method for delivering content and signature files from a source to a destination;

FIG. 5 is a block diagram of a second alternative method for delivering content and signature files from a source to a destination;

FIG. 6 is a block diagram of a third alternative method for delivering content and signature files from a source to a destination;

FIG. 7 is a block diagram of a fourth alternative method for delivering content and signature files from a source to a destination;

FIG. 8 is a block diagram of a minor variation of the fourth alternative method for delivering content and signature files from a source to a destination;

FIG. 9 is a block diagram of a fifth alternative method for delivering content and signature files from a source to a destination; and

FIG. 10 is a block diagram of a sixth alternative method for delivering content and signature files from a source to a destination.

### DETAILED DESCRIPTION OF THE EMBODIMENTS

The following discussion of the embodiments of the invention directed to methods for providing digital signatures for authenticating the source and content of binary files that are programmed into automotive embedded controllers is merely exemplary in nature, and is in no way intended to limit the invention or its applications or uses. For example, the methods disclosed herein are for authenticating the source and content of binary files for a vehicle electronic control unit (ECU). However, as will be appreciated by those skilled in the art, the method will have application for authenticating the source and content of binary files for other controllers.

Many modern vehicles include electronic control units (ECUs), or controllers, which control the operation of vehicle systems, such as the powertrain, climate control system, infotainment system, body systems, chassis systems, and others. Such controllers require special purpose-designed software in order to perform the control functions. With the increasing number and complexity of these controllers, and the growing threat posed by developers of malicious software, it is more important than ever to authenticate the source and content of binary files that are loaded on automotive controllers. The consequences of using counterfeit software that is not properly validated, or worse, maliciously-designed, in a vehicle controller include unintended behavior of the vehicle or its systems, increased risk of theft of the vehicle, potential tampering with components such as the odometer, and loss of other vehicle features and functions.

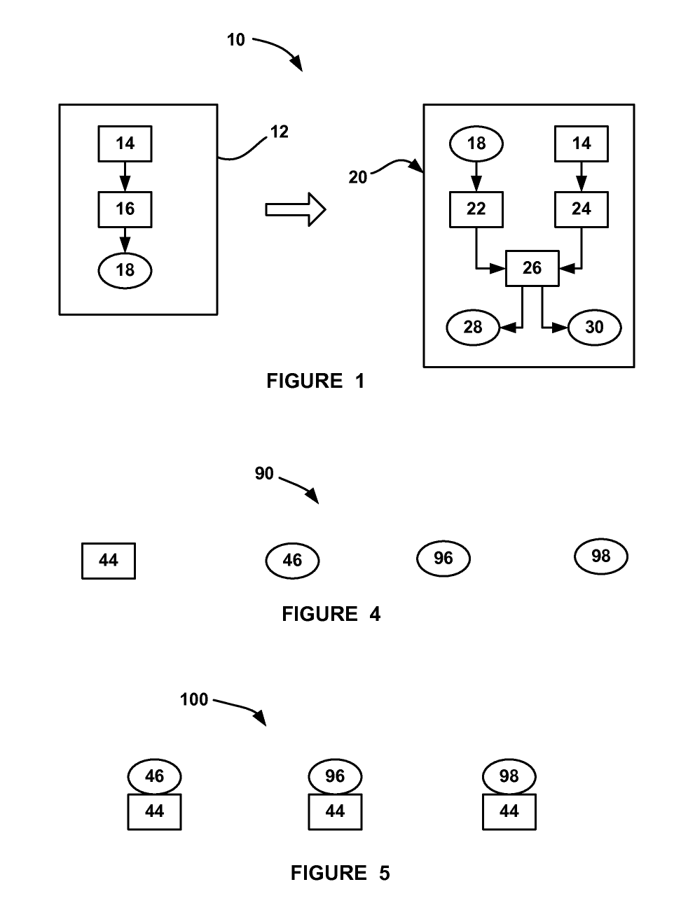

FIG. 1 is a block diagram 10 of a known method for using asymmetric key cryptography—specifically, digital signatures—for authenticating files that are programmed into controllers. As would be understood by those skilled in the art, asymmetric key cryptography uses a pair of mathematically-related keys known as a private key and a public key to encrypt and decrypt a message. To create a digital signature, a signer uses his private key, which is known only to himself, to encrypt a string. The digital signature can later be decrypted by another party using the public key which is paired to the signer's private key.

In a signing step 12, a content file 14 is provided, where the content file 14 could be a piece of software, a calibration file, or other “soft-part” content to be used in a controller. A hash calculation is performed on the content file 14 to produce a hash value 16. The hash value 16 is then encrypted with the signer's private key to produce a digital signature 18.

The digital signature 18 and the content file 14 are then used in a verifying step 20. The digital signature 18 is decrypted using the signer's public key to produce a decrypted hash value 22. Meanwhile, a hash calculation is performed on the content file 14 by the verifier to produce a calculated hash value 24. At box 26, the decrypted hash value 22 is compared to the calculated hash value 24. If the decrypted hash value 22 matches the calculated hash value 24, then a valid determination at oval 28 is issued, and the content file 14 is used. If the decrypted hash value 22 does not match the calculated hash value 24, then an invalid determination at oval 30 is issued, and the content file 14 is not used.

As discussed previously, the digital signature technique shown in FIG. 1 is known, but there are many practical issues associated with managing the content file 14 and the digital signature 18 from the signing step 12 to the verifying step 20. The presently disclosed methods resolve those issues.

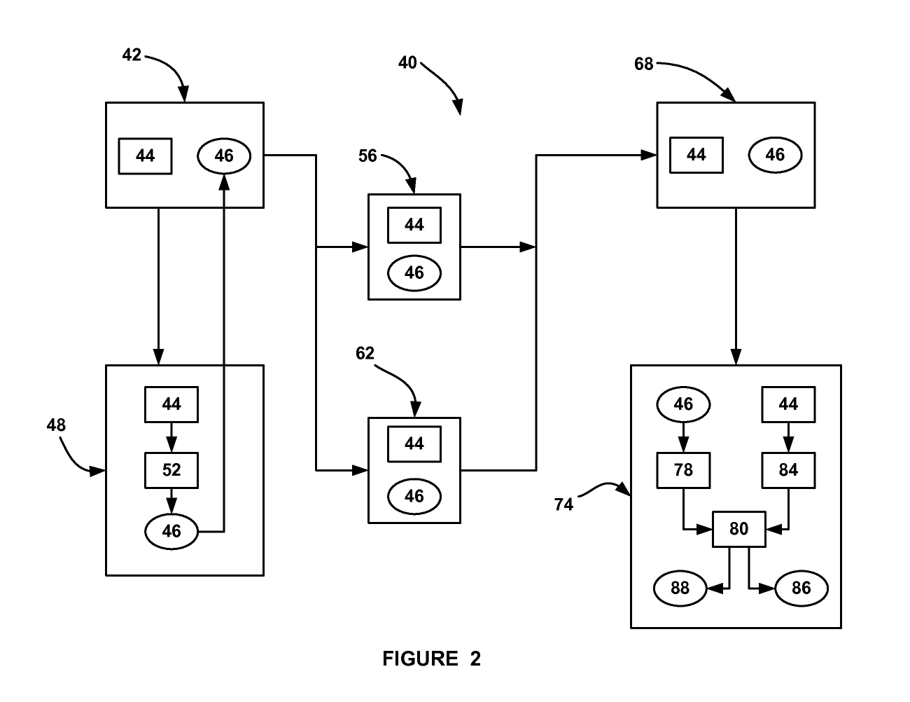

FIG. 2 is a block diagram 40 showing a method for signing and verifying electronic content using a digital signature, including the delivery of content and signature files from programming source to executing controller. A file repository 42 stores a software executable and/or a calibration file, collectively known as a content file 44. The content file 44 is typically a binary file. It is desired to obtain a digital signature 46 for the content file 44. In order for the content file 44 to be digitally signed, the content file 44 is provided to a signing server 48. On the signing server 48, a hash calculation is performed on the content file 44 to produce a hash value 52. The hash value 52 is encrypted using a private key of the signing server 48, where the encryption produces the digital signature 46. The digital signature 46 is then provided back to the repository 42.

At this point, the content file 44 and the digital signature 46 both exist in the repository 42. The challenge is then to deliver the content file 44 and the digital signature 46 through the various business systems used by the auto manufacturer and install and validate the content file 44 on a controller in a vehicle. In general, an auto manufacturer will have at least two organizations or departments responsible for installing software and calibration files on controllers in vehicles, namely, manufacturing and service. FIG. 2 shows a manufacturing database 56, used by the auto manufacturer's manufacturing department for managing electronic files which are installed as “parts” in production vehicles. FIG. 2 likewise shows a service database 62, used by the auto manufacturer's service department for managing electronic files which are installed as “service parts” in vehicles that are worked on in a service facility. As shown in FIG. 2, the manufacturing database 56 and the service database 62 both receive copies of the content file 44 and the digital signature 46 to be used for the respective functions of the manufacturing and service departments.

In order to actually install the content file 44 on a controller in a vehicle, a programming tool 68 is used. As shown, the programming tool 68 also receives a copy of the content file 44 and the digital signature 46. That is, the manufacturing department could provide the content file 44 and the digital signature 46 from the manufacturing database 56 to the programming tool 68 for installation on a new production vehicle, or the service department could provide the content file 44 and the digital signature 46 from the service database 62 to the programming tool 68 for installation on a vehicle being serviced. Details of how the content file 44 and the digital signature 46 are handled by the repository 42 the manufacturing database 56, the service database 62 and the programming tool 68 are specified in the alternative methods discussed below.

The next step is for the programming tool 68 to install the content file 44 on a controller in a vehicle. ECU 74 is the controller that will actually use the content file 44. Following is a brief discussion of the architecture of the ECU 74. The software on the ECU 74 consists of a bootloader, a software executable, and one or more calibration files. For the purposes of this discussion, the ECU 74 is assumed to have a single central processing unit (CPU). In actual vehicles, the ECU 74 could have multiple CPUs, and each CPU would have a bootloader, a software executable, and one or more calibration files.

The bootloader in the ECU 74 is responsible for validating and installing new software executables and calibration files. Thus, the functions described in this paragraph are performed by the bootloader in the ECU 74. The programming tool 68 provides the content file 44 and the digital signature 46 to the ECU 74. The digital signature 46 is decrypted by the bootloader using the embedded public key to produce a decrypted hash value 78. The public signing key may be resident in the ECU 74 or be provided to the ECU 74 in conjunction with the content file 44 and the digital signature 46. Meanwhile, a hash calculation is performed on the content file 44 by the bootloader to produce a calculated hash value 84. At box 80, the decrypted hash value 78 is compared to the calculated hash value 84. If the decrypted hash value 78 matches the calculated hash value 84, then a valid determination 88 is issued, and the content file 44 is used. If the content file 44 to be used is a software executable, the bootloader installs it as the new software executable on the ECU 74. If the content file 44 to be used is a calibration file, the bootloader installs it as one of the one or more calibration files on the ECU 74. If the decrypted hash value 78 does not match the calculated hash value 84, then an invalid determination 86 is issued, and the content file 44 is not used on the ECU 74.

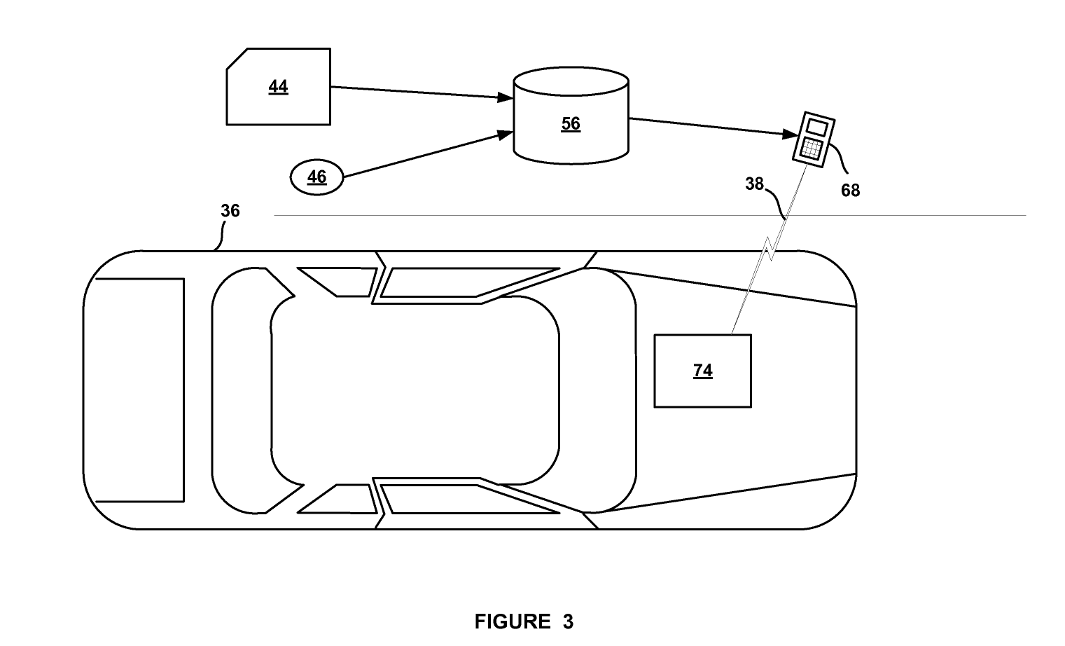

FIG. 3 is a schematic diagram showing how electronic content and digital signature files are physically delivered to a vehicle controller. A vehicle 36 includes the ECU 74 shown in FIG. 2 and discussed above. The ECU 74 could control the engine, transmission, chassis, body, infotainment, or other system on the vehicle 36. The content file 44 and the digital signature 46 are provided to a central database, shown here as the manufacturing database 56. The transfer of the content file 44 and the digital signature 46 to the manufacturing database 56 could take place over a company network. The manufacturing database 56 provides the content file 44 and the digital signature 46 to the programming tool 68, where this transfer could be accomplished by attaching the programming tool 68 to a computer which has access to the database 56. The programming tool 68 communicates with the ECU 74 via a connection 38, which may be wired or wireless. With the connection 38 established, the content file 44 and the digital signature 46 can be downloaded from the programming tool 68 to the ECU 74, where the bootloader can perform the security verification functions discussed previously.

The method shown by FIG. 2 is a generic approach to delivering the content and digital signature files from the repository 42 to the ECU 74. Several alternative embodiments of the file handling and delivery method are envisioned, as discussed below. In general, the digital signature 46 can be embedded within, appended to, or detached from the content file 44. Additionally, there are scenarios where more than one digital signature 46 is necessary, and the file handling and delivery methodology must accommodate this situation. More than one digital signature 46 may be necessary, for example, when a country demands that an auto manufacturer disclose the private key used in software sold in the country, in which case the auto manufacturer will want to use a unique private key for that country, which is different from the private key it uses for software in vehicles it sells in the rest of the world. Each of the alternative embodiments discussed below has certain features and advantages. An automotive manufacturer may choose one of the alternatives, or a hybrid or combination of the alternatives, as best suited to the manufacturer's organizational structure, business processes, and IT business systems. Three digital signatures are shown in each of the alternative methods discussed below, but it is to be understood that more or fewer than three may be used in practice.

FIG. 4 is a block diagram 90 of a first alternative method for delivering electronic content and signature files from a source to a destination. In addition to the content file 44 and the digital signature 46, a second digital signature 96 and a third digital signature 98 are shown. In the method of the block diagram 90, the content file 44 and the digital signatures 46, 96 and 98 are all separate files that are detached from one another and each has its own part number. That is, this method uses four data files and four part numbers to represent the content file 44 and the digital signatures 46, 96 and 98. Each of the files would have a unique part number in the bill of materials, would be stored as a separate item in the manufacturing database 56 and the service database 62, and would be “released” or approved for production in the same manner as currently used for other software parts. This method provides a great deal of flexibility, as any number of digital signature files could be used with a particular piece of electronic content. This method also requires no custom programming of the bootloader, as it would be incumbent upon the manufacturing or service department to provide the proper digital signature (46, 96 or 98) with the content file 44 to the programming tool 68. Then the programming tool 68 would download the content file 44 and the digital signature (46, 96 or 98—whichever one it receives from the manufacturing database 56 or the service database 62) to the ECU 74, where the bootloader would proceed as described previously.

FIG. 5 is a block diagram 100 of a second alternative method for delivering electronic content and signature files from a source to a destination. In the method of the block diagram 100, as shown at the left, the content file 44 is combined with the digital signature 46 to produce a single binary file that would represent one part number in the bill of materials and the databases 56 and 62. Likewise, the content file 44 would be combined with the digital signature 96 to produce a second binary file and a second part number, and the content file 44 would be combined with the digital signature 98 to produce a third binary file and a third part number. That is, this method uses three data files and three part numbers to represent the content file 44 and the digital signatures 46, 96 and 98. Similarly to the first alternative method of FIG. 4, each of the files in this method would have a unique part number in the bill of materials, would be stored as a separate item in the manufacturing database 56 and the service database 62, and would be “released” or approved for production in the same manner as currently used for other software parts. This method also provides a great deal of flexibility, as any number of digital signature files could be used with a particular piece of electronic content. Also in this method, it would be incumbent upon the manufacturing or service department to provide the proper part file (the content file 44 combined with one of the digital signatures 46, 96 or 98) to the programming tool 68. Then the programming tool 68 would download the combined file to the ECU 74, where the bootloader would proceed as described previously. In this case, the bootloader would be programmed to know that the first part of the combined file, represented by a certain address range, contains the digital signature data.

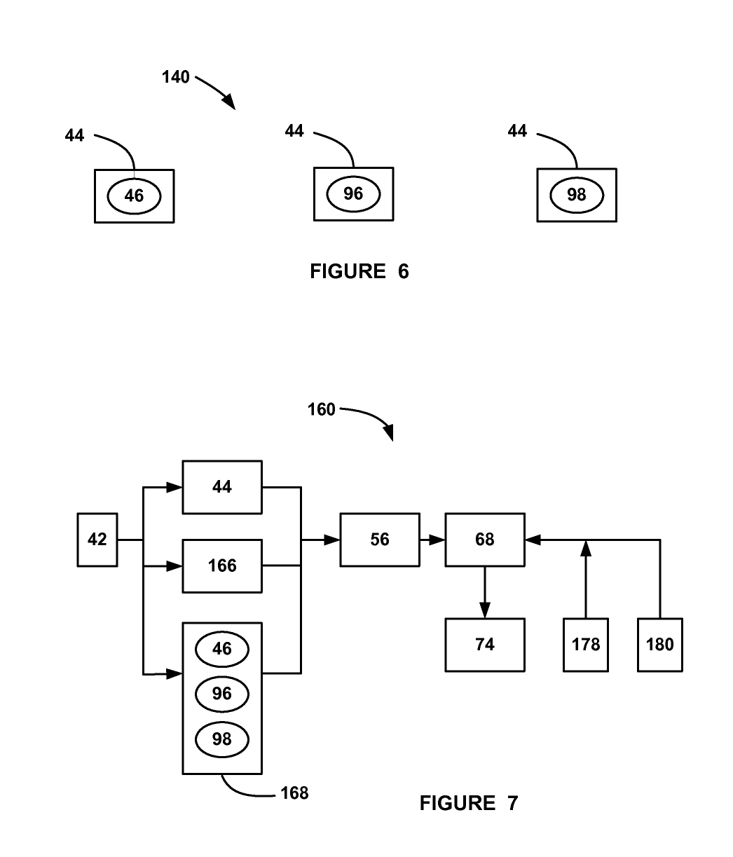

FIG. 6 is a block diagram 140 of a third alternative method for delivering electronic content and signature files from a source to a destination. This method is similar to the method of FIG. 5, except in this method the digital signature file is embedded within the content file 44 rather than the two files being simply combined as shown in the second alternative method of FIG. 5. That is, the digital signature 46 is embedded within the content file 44 to produce a single binary file which would represent one part number in the bill of materials and the databases 56 and 62. Likewise, the digital signature 96 would be embedded within the content file 44 to produce a second binary file and a second part number, and the digital signature 98 would be embedded within the content file 44 to produce a third binary file and a third part number. Thus, this method uses three data files and three part numbers to represent the content file 44 and the digital signatures 46, 96 and 98. Embedding the digital signature files within the content file 44 would be done in the same way as other data, such as part numbers and checksums, are currently embedded in software files. As with the second alternative method above, part release and change management processes and tools would not be affected. In this third alternative method, the bootloader would need to know where the digital signature data is embedded within the content file 44, so that the bootloader can use the digital signature data to produce the decrypted hash value 78, and also so that the bootloader can skip the digital signature data when determining the calculated hash value 84.

FIG. 7 is a block diagram 160 of a fourth alternative method for delivering electronic content and signature files from a source to a destination. Because other data sources are involved, FIG. 7 includes more than just the content file 44 and the various digital signature files. The repository 42, introduced in FIG. 2 and discussed previously, produces three files. One of the files is the content file 44. A second file is a metadata file 166, which contains information about the part number represented by the content file 44. A third file is a signature repository file 168, which contains digital signatures 46, 96 and 98 in a single data file, in eXtensible Markup Language (XML) format, for example. Only one part number is used in this alternative, and the three files 44, 166 and 168 all have matching file names based on the part number, with different file type extensions. The files 44, 166 and 168 are provided to the manufacturing database 56. The service database 62 would also receive the files 44, 166 and 168, but is omitted from FIG. 7 for simplicity. The manufacturing database 56 provides the files 44, 166 and 168 to the programming tool 68, which in turn programs the ECU 74.

In the fourth alternative method shown in FIG. 7, it remains to be shown how the programming tool 68 and the ECU 74 know which of the signatures in the signature repository file 168 to use, and how to determine what public key to use to decrypt the signature. Each of the digital signatures 46, 96 and 98 is associated with a “production option”, which identifies parameters about the vehicle. The public key identifiers and values for each of the digital signatures 46, 96 and 98 are contained in a key database 178. Production option data is contained in an options database 180. Each vehicle being produced has a known production option code that is provided to the programming tool 68 from the options database 180. Knowing the production option code for the vehicle, the programming tool 68 can select the appropriate associated digital signature (among signatures 46, 96 and 98), and can also retrieve the proper public key from the database 178. The programming tool 68 would then download the content file 44 and the proper digital signature (46, 96 or 98) to the ECU 74 for validation and installation.

It is also possible, in the fourth alternative method of FIG. 7, to have the programming tool 68 operate in a trial and error mode, without access to the key database 178 or the option database 180. In the trial and error mode, the programming tool 68 would send the digital signatures 46, 96 and 98 to the ECU 74 one at a time, and the bootloader would determine which signature to use based on its embedded public key. This trial and error mode requires less sophistication in the programming tool 68, but requires customization of the bootloader program to individual vehicle options.

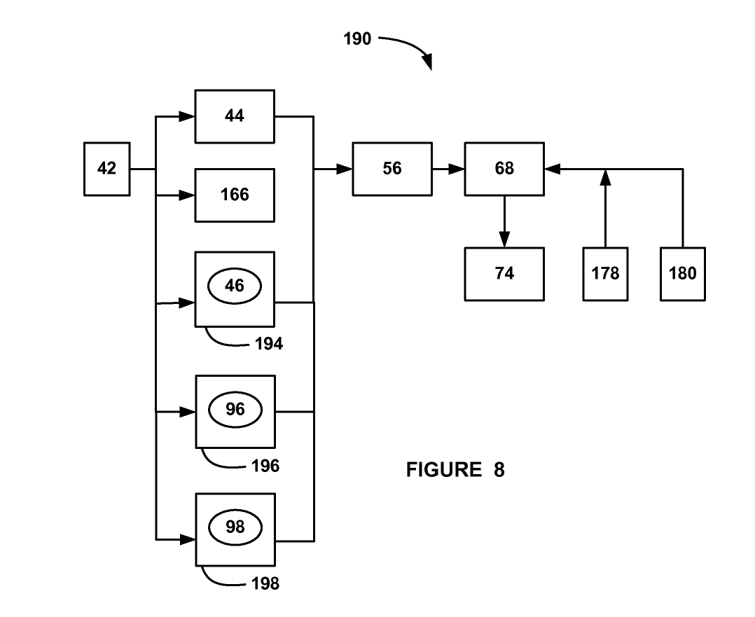

FIG. 8 is a block diagram 190 of the fourth alternative method of FIG. 7, with a minor variation. In this variation of the fourth alternative, each of the digital signatures is contained in its own file; that is, the digital signature 46 is contained in a first XML file 194, the digital signature 96 is contained in a second XML file 196, and the digital signature 98 is contained in a third XML file 198. The XML files 194, 196 and 198, along with the content file 44 and the metadata file 166, are all produced by the repository 42, are all provided to the manufacturing database 56, and are all available to the programming tool 68. Here again, all of the files—44, 166, 194, 196 and 198—have matching file names based on the single part number, with different file extensions. An advantage of this variation of the fourth alternative is that a new digital signature can be accommodated with a new XML file, without having to create a new signature repository file 168. However, business processes must be designed to ensure that the new digital signature XML file is provided to the manufacturing database 56 and the programming tool 68. The actual selection of a digital signature, and flash programming of the ECU 74 by the programming tool 68 is the same in this variation as described previously for the fourth alternative method of FIG. 7.

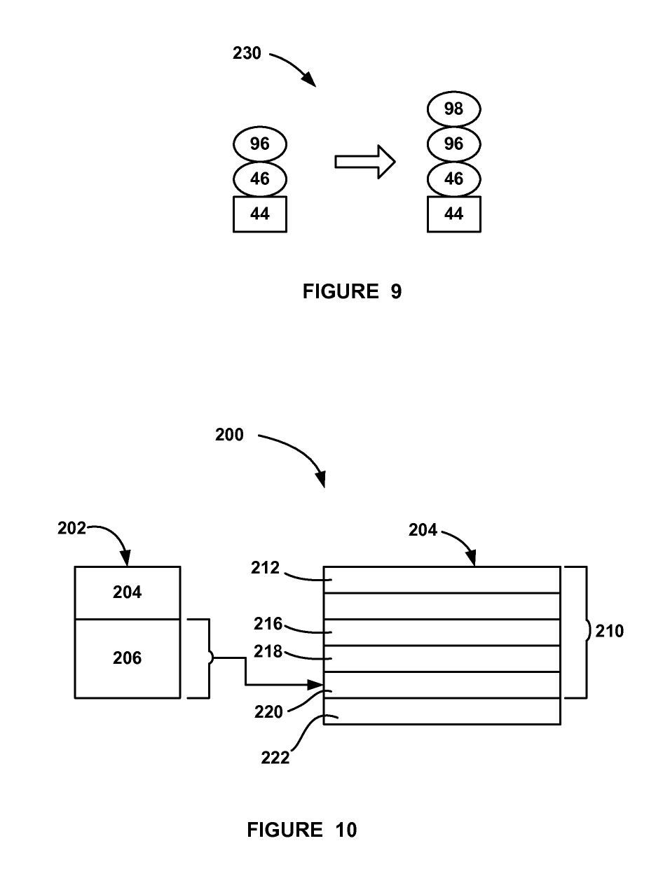

FIG. 9 is a block diagram 230 of a fifth alternative method for delivering electronic content and signature files from a source to a destination. This method is an extension of the second alternative method shown in FIG. 5 however, in this method, the content file 44 and multiple digital signature files are combined and released as one file and part number. As shown at the left of FIG. 9, the content file 44 and the digital signatures 46 and 96 are combined. This combination is given a part number, released for production, transferred to the manufacturing database 56, and so forth. If a new digital signature is required, such as the digital signature 98, then a new part number would be created and released, where the file would be a combination of the content file 44 and the three digital signatures 46, 96 and 98. This fifth alternative method is flexible, in that a single part number and file can be used with multiple keys or signatures. The method is also simple, in that it will work with existing business processes and databases.

In the fifth alternative method of FIG. 9, it is necessary for the programming tool 68 to provide the proper signature to the ECU 74. This can be done using the trial and error mode discussed previously, where the programming tool 68 sends the digital signatures one at a time and the ECU 74 uses the signature which matches the public key embedded in the bootloader. The programming tool 68 could also issue a data request to the ECU 74 to retrieve the identity of the bootloader's embedded public key, and then the programming tool 68 would send only the appropriate digital signature to the ECU 74.

FIG. 10 is block diagram 200 of a sixth alternative method for delivering electronic content signature files from a source to a destination. In this embodiment, ECU content and security parameters are combined and released as one file to allow for validation of programming information before programming. A content file 202 is shown including its file header 204 and the actual content 206 to be programmed into the ECU. Although not specifically shown above, the content file 44 does include a file header. In the embodiments discussed above, the content file 44 was hashed and the hash was signed. In this embodiment, the content 206 is hashed and the hash value is put in the file header 204. The file header 204 is signed instead of the actual content 206. A detailed depiction of the file header 204 is shown on the right side and includes a memory slot 212 for part information including part numbers, address ranges, module ID, etc., a memory slot 216 for the signature, and a memory slot 218 for the signature key ID. The hash value of the content 206 is shown in memory slot 220 of the file header 204. The contents of memory slots 212, 216, 218 and 220, represented as memory section 210, are signed and the signature is placed in memory slot 222. The file header 204 includes the instructions to program the part that can be validated prior to erasing and writing the flash. The supplier that provides the ECU content files would have the signature populated by the same release tools that process in-house files.

As will be well understood by those skilled in the art, the several and various steps and processes discussed herein to describe the invention may be referring to operations performed by a computer, a processor or other electronic calculating device that manipulates and/or transforms data using electrical phenomenon. Those computers and electronic devices may employ various volatile and/or non-volatile memories including non-transitory computer-readable medium with an executable program stored thereon including various code or executable instructions able to be performed by the computer or processor, where the memory and/or computer-readable medium may include all forms and types of memory and other computer-readable media.

The foregoing discussion disclosed and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A method for providing digital signatures for authenticating content files that are flash programmed into a controller, said method comprising:
providing a content file and one or more digital signatures from a file repository source;
transferring the content file and the one or more digital signatures from the repository to a production database;
transferring the content file and the one or more digital signatures from the production database to a programming tool, said programming tool being a device configured to flash program the controller;
transferring the content file and the one or more digital signatures from the programming tool to the controller; and
using the one or more digital signatures by the controller to verify the authenticity of the content file and the repository.

2. The method of claim 1 wherein the controller verifies the authenticity of the content file and the repository source by using a public key of the repository source to decrypt the one or more digital signatures, and compares a decrypted hash value to a hash value calculated from the content file.

3. The method of claim 2 wherein the content file includes a file header, and wherein the file header includes the hash value calculated from content in the content file.

4. The method of claim 1 wherein the content file and the one or more digital signatures are each separate files with separate part numbers.

5. The method of claim 1 wherein each of the one or more digital signatures is individually combined with the content file to create a unique file with its own part number.

6. The method of claim 1 wherein each of the one or more digital signatures is individually embedded within the content file to create a unique file with its own part number.

7. The method of claim 1 wherein all of the one or more digital signatures are combined into a single digital signature file, and the digital signature file and the content file have the same part number.

8. The method of claim 7 wherein the digital signature file is an eXtensible Markup Language (XML) file.

9. The method of claim 1 wherein each of the one or more digital signatures is contained in its own digital signature file, and all of the digital signature files and the content file have the same part number.

10. The method of claim 8 wherein the digital signature files are eXtensible Markup Language (XML) files.

11. The method of claim 1 wherein the content file and all of the one or more digital signatures are combined into a single file with a single part number.

12. The method of claim 1 wherein the controller is an embedded controller in an automobile.

13. A method for providing digital signatures for authenticating content files that are flash programmed into an electronic control unit (ECU) on a vehicle, said method comprising:
providing a content file and one or more digital signatures from a file repository source;
transferring the content file and the one or more digital signatures from the repository to a production database;
transferring the content file and the one or more digital signatures from the production database to a programming tool, said programming tool being a device configured to flash program the ECU;
transferring the content file and the one or more digital signatures from the programming tool to the ECU; and
using the one or more digital signatures by the ECU to verify the authenticity of the content file and the repository, wherein the ECU verifies the authenticity of the content file and the repository by using a public key of the repository to decrypt the one or more digital signatures, and compares a decrypted hash value to a hash value computed from the content file.

14. The method of claim 13 wherein the content file and the one or more digital signatures are each separate files with separate part numbers.

15. The method of claim 13 wherein each of the one or more digital signatures is individually combined with the content file to create a unique file with its own part number.

16. The method of claim 13 wherein each of the one or more digital signatures is individually embedded within the content file to create a unique file with its own part number.

17. The method of claim 13 wherein all of the one or more digital signatures are combined into a single digital signature file, and the digital signature file and the content file have the same part number.

18. The method of claim 13 wherein each of the one or more digital signatures is contained in its own digital signature file, and all of the digital signature files and the content file have the same part number.

19. The method of claim 13 wherein the content file and all of the one or more digital signatures are combined into a single file with a single part number.

20. A system for providing digital signatures for authenticating content files that are flashed programmed into a controller, said system comprising:
means for providing a content file and one or more digital signatures from a file repository source;
means for transferring the content file and the one or more digital signatures from the repository to a production database;
means for transferring the content file and the one or more digital signatures from the production database to a programming tool, said programming tool being a device configured to flash program the controller;
means for transferring the content file and the one or more digital signatures from the programming tool to the controller; and
means for using the one or more digital signatures by the controller to verify the authenticity of the content file and the repository.
